(19) United States
(12) Patent Application Publication
(10) Pub. No.: US 2024/0044275 A1
(43) Pub. Date: Feb. 8, 2024

(54) VERFAHREN ZUR DIAGNOSE EINES PARTIKELFILTERS FÜR EINEN VERBRENNUNGSMOTOR

(71) Applicant: Robert Bosch GmbH, Stuttgart (DE)

(72) Inventors: Alexandre Wagner, Stuttgart (DE); Benedikt Alt, Heimsheim (DE); Evgenij Pachomow, Marbach Am Neckar (DE); Thomas Baumann, Kornwestheim (DE)

(21) Appl. No.: 18/364,091

(22) Filed: Aug. 2, 2023

(30) Foreign Application Priority Data
Aug. 3, 2022 (DE) 10 2022 208 086.6

(51) Int. Cl. F01N 11/00; F02D 41/02

(52) U.S. Cl. CPC F01N 11/002; F02D 41/0235; F01N 2550/04

(57) ABSTRACT

A method for diagnosing a particulate filter for an internal combustion engine using a particulate filter model. A plurality of input quantities is received, an expected pressure difference between the inlet and outlet of the particulate filter is determined for an intact particulate filter using the particulate filter model based on the received input parameters, at least one expected pressure difference between the inlet and the outlet of the particulate filter is determined for at least one failure of the particulate filter, a pressure difference between the inlet and the outlet of the particulate filter is measured, the measured pressure difference is compared with the expected pressure difference for the intact particulate filter and the at least one expected pressure difference for the at least one failure of the particulate filter, and at least one diagnostic value for an intact particulate filter or a defective particulate filter is determined.

### BACKGROUND

The present invention relates to a method for diagnosing a particulate filter for an internal combustion engine as well as a computing unit and a computer program for performing such a method.

The strict limit values of today's exhaust gas legislation can no longer be achieved solely with internal engine measures of the internal combustion engines. In order to reduce emissions to the level required by legislation, for example, particulate filters are also used in new vehicles. These are mostly wall-flow filters, which are subjected to strong thermal and mechanical stresses over the life of a vehicle. In order for the strict limits to be met permanently, a high filtration efficiency of the particulate filter must be ensured. As a result, the condition of the filter must be observed continuously.

For evaluating the condition of the particulate filter, the differential pressure is considered as an important measure, which is calculated as the difference in the pressures at the inlet and outlet of the filter. Based on a change in the differential pressure, a change in the flow resistance of the particulate filter can be derived.

DE 10 2017 205 361 A1 shows a corresponding method for detecting a removed or defective particulate filter in an exhaust aftertreatment system of an internal combustion engine, in case of which a differential pressure between the inlet and outlet of the particulate filter is measured and evaluated to monitor the particulate filter. In so doing, a correlation of the measured differential pressure across the particulate filter to an expected differential pressure is determined for an intact reference particulate filter, and for a high correlation it is concluded that the particulate filter is present and intact, and for a low correlation it is concluded that the particulate filter has been removed or is defective.

However, it is difficult to make a statement, solely from the change in the differential pressure, as to what level the particulate filter is clogged with ash or soot, and as to where the current efficiency of the filter actually is. As a result, the known method has only limited robustness, which can result, for example, in an intact filter being incorrectly identified as defective and in unnecessary visits to a workshop.

### SUMMARY

According to the present invention, a method for diagnosing a particulate filter for an internal combustion engine using a particulate filter model during operation of the internal combustion engine, as well as a computing unit and a computer program for performing the method are proposed.

By means of the method according to the invention, a damaged particulate filter for an internal combustion engine can be detected very reliably during operation. In particular, by means of an improved evaluation of the differential pressure signal (measured pressure difference between inlet and outlet of the particulate filter), taking into account important influencing factors with regard to the state of the particulate filter, the robustness of the method is significantly improved in comparison with existing diagnostic approaches. Thereby the risk of false failure detection of an intact particulate filter is reduced and, in turn, a damaged particulate filter is detected earlier. This also applies for difficult boundary conditions, such as e.g., during cold start of the internal combustion engine. A further advantage is that mechanical or thermal partial injuries to the particulate (e.g., penetration holes, gaps, etc.) can also be detected.

Specifically, in the method according to the invention for diagnosing a particulate filter for an internal combustion engine, a plurality of input quantities is received, i.e., the particulate filter model receives a plurality of input quantities. The input quantities can be measured quantities such as pressure and temperature upstream of the particulate filter, exhaust mass flow, and/or oxygen content in the exhaust gas, as well as modeled quantities such as soot and/or ash loading of the particulate filter. For example, the latter can be determined by empirical or physical models and sent to the particulate filter model. The modeled quantities can also be determined by the particulate filter model itself or the computing unit or computer program in which the model is implemented.

In one configuration, the input quantities are parameters that affect the pressure drop across the particulate filter and are thus suitable for modeling the same accordingly. For example, the pressure drop is dependent on the exhaust flow rate and the flow resistance of the particulate filter. The latter, in turn, changes depending on the soot and ash loading of the filter, so that different differential pressures between the filter inlet and the filter outlet occur not only depending on the operating point of the internal combustion engine, but also depending on a current state of the particulate filter. In other words, even with an intact particulate filter, at a constant engine operating point, different differential pressures can occur as a function of the filter state (i.e., as a function of soot and ash loading).

An “intact” particulate filter is intended to be a particulate filter that does not have mechanical and/or thermal damage, does not go below a predetermined filtration rate, and does not violate a predetermined pressure drop across the filter at predetermined engine operating parameters. The mechanical or thermal damage to the particulate filter can be, for example, ruptures of the filter wall or cracks in the filter wall. Exceeding a predetermined limit value for the pressure drop across the filter can occur, for example, due to an impermissible increase in ash loading of the filter, which can occur due to high oil consumption of the engine, for example. An intact particulate filter is also in particular a so-called worst performing acceptable (WPA) filter.

A “defective” particulate filter means a particulate filter that does not meet the above definition for an “intact” particulate filter. A defective particulate filter is in particular also a so-called best performing unacceptable (BPU) filter.

Based on the received input quantities described above, an expected pressure difference for an intact particulate filter is determined using the particulate filter model. This means that the particulate filter model determines and outputs an expected pressure difference between the inlet and outlet of an intact particulate filter, taking into account the received input quantities.

Likewise, based on the received input quantities, the particulate filter model determines at least one expected pressure difference for at least one failure of the particulate filter. In other words, the particulate filter model in this case determines and outputs at least one pressure difference from which at least one potential failure of the particulate filter can be detected, taking into account the received input quantities. In one configuration, pressure differences for a plurality of failures (defects) of the particulate filter can be determined/modeled using the particulate filter model. This can be done on the basis of so-called limit sample components, which can have different defects/damage, for example, and the behavior of which can be depicted using the particulate filter model. In the further course of the description, the modeling of limit sample components is explained in more detail.

In addition to determining the expected differential pressures for an intact particulate filter and at least one failure of the particulate filter, a pressure difference between the inlet and outlet of the particulate filter is measured. This can be done directly by means of a differential pressure sensor, but a difference can also be formed between the readings of two absolute pressure sensors, which can be located at the inlet and outlet of the particulate filter, respectively.

Subsequently, the measured pressure difference is compared with the expected pressure difference for the intact particulate filter and the at least one expected pressure difference for the at least one failure of the particulate filter. In particular, this means determining how much the measured differential pressure deviates from the respective expected pressure difference for an intact particulate filter intact and for a failure of the particulate filter. The received input quantities are advantageously taken into account so that the measured pressure difference and the expected pressure differences are compared to one another under the same boundary conditions.

Based on the comparison of the measured pressure difference with the expected pressure difference for the intact particulate filter and the at least one expected pressure difference for the at least one failure of the particulate filter, at least one diagnostic value for an intact particulate filter or a defective particulate filter is then determined, i.e., it is determined whether there is an intact particulate filter or a defective particulate filter. For example, this can be accomplished by determining a first distance between the measured pressure difference and the expected pressure difference for the intact particulate filter, and a second distance between the measured pressure difference and the at least one expected pressure difference for the at least one failure of the particulate filter. For example, a defective particulate filter can be detected when the second distance is less than the first distance and an intact particulate filter when the first distance is less than the second distance. Thus, in this example, the diagnostic value can be, for example, a distance between the measured differential pressure and the expected values themselves or a parameter dependent on the distance between the measured differential pressure and the expected values.

In one configuration, an action is taken as a function of the diagnostic value. This can include an entry in an error memory and/or an output of a warning, e.g., by means of the engine indicator light. This can also include controlling the internal combustion engine as a function of the diagnostic value. In particular, the mixture metering and/or exhaust aftertreatment can be affected to reduce pollutant emissions when a defective particulate filter has been detected.

The particulate filter model can be stored or implemented in a computing unit, which can be, for example, an engine control unit of the internal combustion engine. The models for determining the modeled input quantities of the particulate filter model, such as soot and ash loading, can also be calculated in the engine control module.

The internal combustion engine can be a gasoline or diesel engine. The internal combustion engine can be operated with any liquid or gaseous fuel obtained from fossil or regenerative sources (e.g., gasoline, diesel, methane, biogas, hydrogen, e-fuels, etc.).

In one configuration, the particulate filter model comprises a data-based model. Alternatively or additionally, the particulate filter model can also comprise a physical model. In one configuration, the data-based model can have at least one so-called machine learning model, such as a neural network and/or at least one state vector machine.

If the particulate filter model includes a physical model, this model can determine the pressure difference between the inlet and outlet of a particulate filter, for example, taking into account the Darcy-Forchheimer equation. This calculates the pressure drop across the filter as a function of the exhaust mass flow rate, the density and viscosity of the exhaust gas, and the area and permeability of the soot/ash and the filter wall. Accordingly, the physical particulate filter model can preferably receive one or more of the exhaust mass flow, the soot and ash loading, and the pressure and the temperature upstream of the particulate filter as input quantities.

The ash loading can be determined, for example, from a cumulative fuel and/or oil consumption; in particular, based on the fuel/oil consumption over the service life of the particulate filter, the ash loading thereof can be determined. For example, soot loading of the particulate filter can be measured by a particulate sensor upstream of the particulate filter or determined by an empirical soot model for the raw soot emissions. Degradation of the soot layer in the particulate filter can be considered using suitable reaction kinetic models.

If the particulate filter model includes a data-based model, which can preferably have at least one machine learning model such as a neural network and/or at least one state vector machine, then this model can also receive the same input quantities as the physical model.

A data-based model is particularly advantageous when, for example, the engine control unit, which contains the model, has a hardware acceleration with which the data-based model can be calculated very efficiently. Hardware acceleration refers to unloading the main processor of a computing unit by delegating specific computationally intensive tasks to hardware specialized for these tasks.

According to one embodiment, the data-based model is trained with corresponding data during the application phase (calibration) of the internal combustion engine. This means that under known boundary conditions (at known engine operating points) with different limit sample components, the model learns the behavior of particulate filters with different errors/properties. Since the physical model also contains parameters that must be determined experimentally, the physical model can also be adapted to the different limit sample components under the same conditions.

According to one embodiment, the particulate filter model thereby determines a plurality of expected pressure differences using limit sample components. Particulate filters with known damage characteristics are to be understood as limit sample components. Likewise, an “empty” particulate filter, i.e., a particulate filter without ash and soot loading, is to be understood as a limit sample component. Additionally, a limit sample representing an optimal, intact particulate filter can also be used.

Through the targeted training of the data-based model or the calibration of the parameters of the physical model with the described limit sample components, the particulate filter model is able to reliably map the pressure drop across the particulate filter for a wide variety of limit and damage cases. This further increases the robustness of the diagnostic function.

The training data for the data-based model or the calibration parameters for the physical model, respectively, can be obtained from measurement data from limit sample components and/or from detailed simulation models. The simulation models are preferably also matched with the limit sample components and can simulate further effects (e.g., partial damage) that cannot be detected using a measurement.

According to one embodiment, the at least one particular diagnostic value is classified by means of binary error classification or multi-class error classification. In other words, a failure can be detected, for example, when a distance between the measured pressure difference between the inlet and the outlet of the particulate filter and an expected pressure difference for a failure of the particulate filter falls below a threshold value (binary classification of the diagnostic value, e.g., “zero” for an intact filter and “one” for a defective filter). Likewise, binary classification can be performed by comparing the distance between the measured pressure difference and an expected pressure difference for an intact particulate filter and an expected pressure difference for a defective particulate filter, as described above.

Alternatively, a multi-class error classification of the diagnostic values can be performed as a function of the distance between the measured pressure difference and the expected values. Probability values for a particular defect resulting from the distance between measured and expected pressure difference can thereby be divided into multiple classes. The multi-class classification provides the advantage that a partial defect/beginning damage can also be determined thereby.

Because the particulate filter model can determine different expected values for different damage cases, partial damage can also be detected in this manner.

According to one embodiment, the at least one classified diagnostic value is averaged over a predetermined period of time. For example, the predetermined period of time can comprise an entire trip of an automobile with an internal combustion engine and particulate filter. In other words, the predetermined period of time can begin at a start of the internal combustion engine and can end at the next shutdown of the engine.

Based on the averaging of the at least one classified diagnostic value over a complete trip, it can be determined more reliably whether the particulate filter can really be classified as intact or damaged. In the case of a binary classification of the diagnostic value, the value averaged over the ride is compared with a threshold value, for example. For example, the threshold value can be selected with p=0.5, where p denotes the probability of exceeding or the significance value.

The robustness of the diagnostic function is significantly increased by the time average of the diagnostic value throughout the entire journey, because, for example, temporary errors in the measurement data acquisition do not directly affect the diagnostic function.

As an alternative to averaging the at least one classified diagnostic value over the entire journey, a sliding average can also be performed over a shorter period of time, or averaging using a recursive filter.

However, in one embodiment, the predetermined time period for averaging the at least one classified error is greater than a predetermined minimum time period to provide sufficient accuracy of the diagnostic function. The minimum period of time represents a compromise in terms of the computational and storage capacity of the computational unit and the accuracy of the method.

A computing unit according to the invention, e.g., a control unit of a vehicle, is configured, in particular in terms of programming, so as to carry out a method according to the invention.

The implementation of a method according to the invention in the form of a computer program or computer program product with program code for carrying out all method steps is also advantageous since this results in particularly low costs, in particular if an executing control device is also used for further tasks and is therefore present in any event. Lastly, a machine-readable storage medium is provided, on which the computer program as described above is stored. Suitable storage media or data carriers for providing the computer program are in particular magnetic, optical and electrical memories, such as hard disks, flash memory, EEPROMs, DVDs, etc. Downloading a program via computer networks (internet, intranet, etc.) is also possible. Such a download can take place in a wired or cabled or wireless manner (e.g., via a WLAN, a 3G, 4G, 5G, or 6G connection, etc.).

Further advantages and configurations of the invention arise from the description and the accompanying drawings.

The invention is illustrated schematically in the drawings on the basis of an embodiment example and is described in detail in the following with reference to the drawings.

### BRIEF DESCRIPTION OF THE DRAWINGS

FIG. 1 shows schematically an arrangement with an internal combustion engine and particulate filter, as can be used in the context of the invention.

FIG. 2 shows a block diagram with individual function blocks for performing a method according to one embodiment.

### DETAILED DESCRIPTION

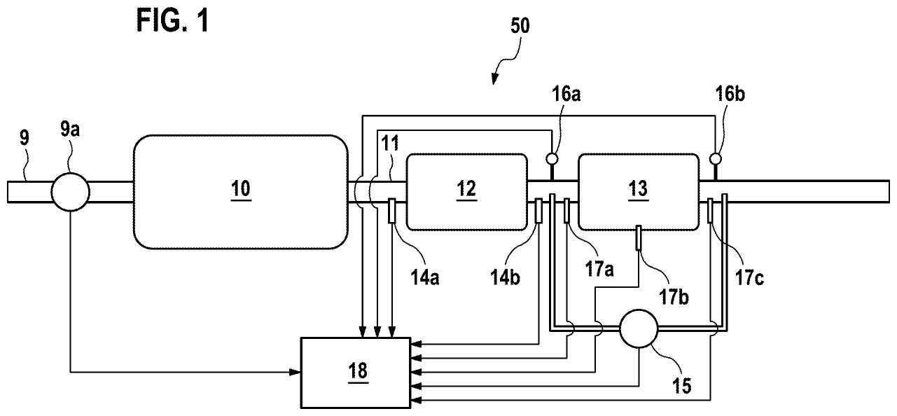

In FIG. 1, an arrangement with an internal combustion engine and particulate filter, as can be used in the context of the invention, is shown schematically and bears the overall reference number 50. As an example, an internal combustion engine 10 with an exhaust aftertreatment system 12, 13 is shown. The internal combustion engine 10 can be embodied as a gasoline or diesel engine, for example. The internal combustion engine can be operated with any liquid or gaseous fuel obtained from fossil or regenerative sources (e.g., gasoline, diesel, methane, biogas, hydrogen, e-fuels, etc.). A hot film air mass sensor (HFM) 9a for measuring an air mass supplied to the internal combustion engine is arranged in an intake section 9 of the internal combustion engine 10. Downstream of the internal combustion engine 10 is arranged an exhaust section 11, via which the exhaust gas of the internal combustion engine is discharged.

The flow of exhaust mass through the exhaust section 11 can be determined from the sum of the mass of air measured by the HFM 9a and the injected mass of fuel. Alternatively or additionally, the exhaust mass flow in the exhaust section 11 can be directly measured by a further flow meter (not shown).

The exhaust aftertreatment system 12, 13 is arranged along the exhaust section 11, which in the illustrated case is arranged in multiple stages. In the direction of flow of the exhaust gas, a catalytic converter 12 is initially provided, which can be embodied as a three-way catalyst, for example. One lambda probe 14a, 14b each is arranged both upstream and downstream of the catalytic converter 12, with which the residual oxygen content in the exhaust gas can be determined before and after the catalytic converter 12. These measured quantities are used to regulate the fuel-air ratio required in the catalytic converter and can additionally flow into a reaction kinetic model for calculating particulate filter regeneration.

The particulate filter 13 is connected downstream of the catalytic converter 12, and one particulate sensor 16a, 16b each is arranged both upstream and downstream of the particulate filter 13. With this, the particulate mass in the exhaust gas can be determined before and after the particulate filter 13. The particulate sensor 16a upstream of the particulate filter 13 is thus suitable for determining the soot loading of the particulate filter, whereas the function of the particulate filter can be monitored with the particulate filter 16b located downstream of the particulate filter 13. In addition, the particulate filter 13 is equipped with multiple temperature sensors 17a-17c, the signals of which can serve as input quantities for a particulate filter model as well as for monitoring the function of the particulate filter 13. The catalyst 12 and particulate filter 13 can also be integrated into a common housing in the form of a so-called four-way catalyst (FWC), that is, a catalyst-coated particulate filter 13.

A differential pressure sensor 15 is also provided for diagnosing the particulate filter 13, with which the pressure differential (differential pressure) between a filter inlet and a filter outlet of the particulate filter 13 can be determined. It is also conceivable that the differential pressure is determined by means of two absolute pressure sensors arranged upstream and downstream of the particulate filter 13. All sensors 9a-17c are connected by means of signal lines to a computing unit 18, which can be a component of a higher-level engine controller, for example.

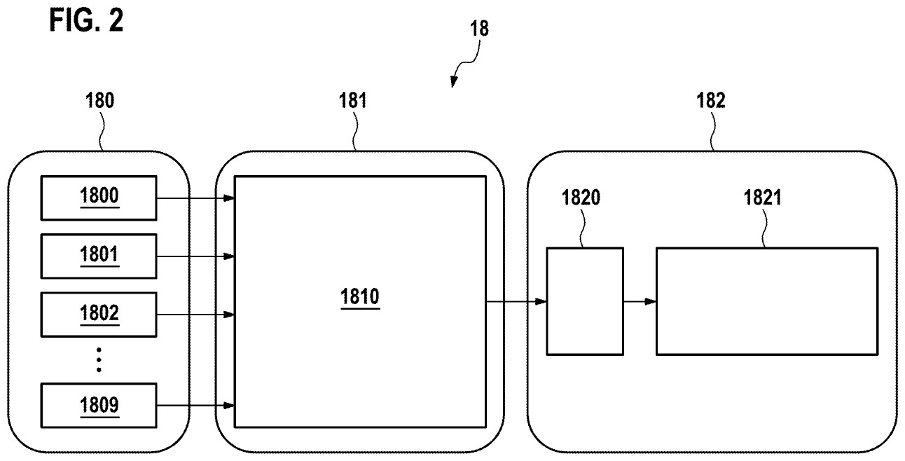

The computational unit 18 can include a particulate filter model, with which different failures of the particulate filter 13 can be detected using the sensor signals described above. One embodiment of the present particulate filter model is described in more detail with reference to the following FIG. 2.

FIG. 2 shows a block diagram of the computing unit 18 with individual function blocks 180, 181, 182 for performing a method according to one embodiment.

The first function block 180 thereby serves for processing the inlet signals 1800-1809, which are subsequently supplied to a particulate filter model 1810 in the second function block 181, which provides diagnostic values for the particulate filter 13 based on the input quantities. For example, the inlet values can comprise one or more of a measured exhaust mass flow rate, a measured pressure, a measured temperature upstream of the particulate filter, and/or a measured differential pressure between the inlet and outlet of the particulate filter. Likewise, modelled quantities can be provided to the particulate filter model 1810, such as ash and soot loading of the particulate filter, for example originating from further engine control models. The processing of the input signals can comprise, for example, adjusting a computing grid and/or filtering of one or more measurement signals. Input signals with high dynamics, such as the differential pressure between the inlet and outlet of the particulate filter or exhaust mass flow, can flow into the particulate filter model 1810 at a higher sampling rate than slow dynamic signals such as exhaust temperature.

In the present described example, after such processing of the inlet signals, a sequence of multiple individual signal values is combined into a vector (e.g., five consecutive measured values for the differential pressure or the exhaust gas mass flow and one measured value for the exhaust gas temperature).

These vectors with the corresponding signal values are passed to the second functional block 181, which contains the particulate filter model 1810, which can include, for example, at least one neural network or at least one state vector machine as a machine learning model. Based on the inlet vectors, for example, a condition of the particulate filter 13 (intact or defective) is determined by means of a trained neural network. The measured pressure difference between the inlet and outlet of the particulate filter 13 is thereby compared with expected values for the pressure difference on an intact particulate filter 13 or particulate filter 13 with a defect. When the neural network has been trained with various limit sample components (particulate filter having defined damage, empty particulate filter, intact particulate filter), various failures of the particulate filter can be detected. These defects can either be output as binary diagnostic values (i.e., “zero” for an intact filter and “one” for a defective filter), or divided into multiple classes based on multiple probability values for a given failure. The multi-class classification provides the advantage that a partial defect/beginning damage can also be determined thereby.

The diagnostic values/output quantities of the particulate filter model 1810 are in turn supplied here to an averaging determination 1820 in the third functional block 182. This means that the diagnostic values are averaged over, for example, an entire journey of a motor vehicle with an internal combustion engine and particulate filter (from engine start to engine stop). Thus, diagnostic values occurring only temporarily can be eliminated and the robustness of the diagnosis can be increased.

The averaging determination 1820 subsequently sends the averaged diagnostic values to the sub-function block 1821, wherein one or more defects of the particulate filter 13 are determined based on the same. A result can then be used to take one or more actions, such as entries in an error memory, outputting a warning, e.g., by means of the engine light, etc. This can also include controlling the internal combustion engine as a function of the diagnostic value. In particular, the mixture addition measurement and/or exhaust aftertreatment can be affected to reduce pollutant outlet when a defective particulate filter has been detected.

1. A method for diagnosing a particulate filter (13) for an internal combustion engine (10) by means of a particulate filter model (1810) during operation of the internal combustion engine (10), the method comprising:
receiving a plurality of input quantities (1800-1809);
determining an expected pressure difference between the inlet and outlet of the particulate filter (13) for an intact particulate filter (13) by means of the particulate filter model (1810) based on the received input quantities (1800-1809);
determining at least one expected pressure difference between the inlet and the outlet of the particulate filter (13) for at least one defect of the particulate filter (13) based on the received input quantities (1800-1809) by means of the particulate filter model (1810);
measuring a pressure difference between the inlet and the outlet of the particulate filter (13),
comparing the measured pressure difference with the expected pressure difference for the intact particulate filter (13) and the at least one expected pressure difference for the at least one failure of the particulate filter (13); and
determining at least one diagnostic value for an intact particulate filter (13) or a defective particulate filter (13) based on comparing the measured pressure difference with the expected pressure difference for the intact particulate filter and the at least one expected pressure difference for the at least one defect of the particulate filter.

2. The method according to claim 1, wherein the particulate filter model (1810) comprises a data-based and/or a physical model.

3. The method according to claim 1, wherein the particulate filter model (1810) includes a machine learning model.

4. A method according to claim 1, wherein the particulate filter model (1810) determines a plurality of expected pressure differences for an intact particulate filter (13) and/or for at least one defect of the particulate filter (13) using limit sample components.

5. The method according to claim 1, wherein the at least one diagnostic value is classified by means of binary error classification or multi-class error classification.

6. The method according to claim 5, wherein the at least one classified diagnostic value is averaged over a predetermined period of time greater than a predetermined minimum period of time.

7. The method according to claim 6, wherein the averaging of the at least one classified diagnostic value is performed by means of a recursive filter.

8. The method according to claim 1, wherein an action is taken as a function of the diagnostic value.

9. The method according to claim 8, wherein the action comprises one or more of entering in an error memory, outputting an alert, or controlling the internal combustion engine as a function of the diagnostic value.

10. A computer (18) configured to diagnose a particulate filter (13) for an internal combustion engine (10) by means of a particulate filter model (1810) during operation of the internal combustion engine (10), by:
receiving a plurality of input quantities (1800-1809);
determining an expected pressure difference between the inlet and outlet of the particulate filter (13) for an intact particulate filter (13) by means of the particulate filter model (1810) based on the received input quantities (1800-1809);
determining at least one expected pressure difference between the inlet and the outlet of the particulate filter (13) for at least one defect of the particulate filter (13) based on the received input quantities (1800-1809) by means of the particulate filter model (1810);
measuring a pressure difference between the inlet and the outlet of the particulate filter (13), comparing the measured pressure difference with the expected pressure difference for the intact particulate filter (13) and the at least one expected pressure difference for the at least one failure of the particulate filter (13); and
determining at least one diagnostic value for an intact particulate filter (13) or a defective particulate filter (13) based on comparing the measured pressure difference with the expected pressure difference for the intact particulate filter and the at least one expected pressure difference for the at least one defect of the particulate filter.

11. (canceled)

12. A non-transitory, machine-readable storage medium containing instructions that when executed by a computer cause the computer to diagnose a particulate filter (13) for an internal combustion engine (10) by means of a particulate filter model (1810) during operation of the internal combustion engine (10), by:
receiving a plurality of input quantities (1800-1809);
determining an expected pressure difference between the inlet and outlet of the particulate filter (13) for an intact particulate filter (13) by means of the particulate filter model (1810) based on the received input quantities (1800-1809);
determining at least one expected pressure difference between the inlet and the outlet of the particulate filter (13) for at least one defect of the particulate filter (13) based on the received input quantities (1800-1809) by means of the particulate filter model (1810);
measuring a pressure difference between the inlet and the outlet of the particulate filter (13),
comparing the measured pressure difference with the expected pressure difference for the intact particulate filter (13) and the at least one expected pressure difference for the at least one failure of the particulate filter (13); and
determining at least one diagnostic value for an intact particulate filter (13) or a defective particulate filter (13) based on comparing the measured pressure difference with the expected pressure difference for the intact particulate filter and the at least one expected pressure difference for the at least one defect of the particulate filter.
